(19) United States
(12) Patent Application Publication
(10) Pub. No.: US 2014/0127469 A1
(43) Pub. Date: May 8, 2014

(54) FRICTION MATERIAL

(71) Applicant: Miba Frictec GmbH, Laakirchen (AT)

(72) Inventors: Franz HEITZENDORFER, Scharnstein (AT); Volker FOEGE, Bad Ischl (AT); Falk NICKEL, Gmunden (AT)

(73) Assignee: Miba Frictec GmbH, Laakirchen (AT)

(21) Appl. No.: 14/056,712

(22) Filed: Oct. 17, 2013

(30) Foreign Application Priority Data
Nov. 6, 2012 (AT) A 50490/2012

(51) Int. Cl. F16D 69/00

(52) U.S. Cl. CPC F16D 69/00
USPC 428/169; 428/167

(57) ABSTRACT

The invention relates to a friction material (1) for a friction element having a conical contact surface for the friction material (1), with a base body having the form of a strip (2) having a length (3) and a width (4), and the strip (2) has several thin areas which only extend over a part of the width (4) of the strip (2).

The invention relates to a friction material for a friction element having a conical contact surface for the friction material, with a base body having the form of a strip having a length and a width as well as a friction element having a conical contact surface whereon a friction material having the form of a strip is arranged.

Cone rings or double-cone rings of transmission synchronizers have been known from prior art. These elements have one of two conical surfaces that are being meshed during the switching operation. To prevent slipping, a friction layer that can be meshed with the corresponding mate surface is attached to these conical surfaces. These friction layers are usually made from a fabric. For this purpose, the strip corresponding to the contour of the conical contact surface in the required width and length is cut out of a planar fabric. Caused by the fact that the outside radius and the inside radius of the conical surface do not have the same size, a large portion of cutoff incurs, as the individual strips cannot be cut out of the fabric edge to edge. This is a considerable expense factor in producing these cone rings, in particular with expensive fabrics, such as carbon fabric.

The objective of the present invention is to propose a possibility to reduce the off-cut in producing friction materials for cone rings.

The objective is achieved by the aforementioned friction material, where the strip has several thin areas, which extend only over a part of the strip. The objective is furthermore achieved by the above-mentioned friction element, where the friction material is embodied according to the invention.

It is in this case advantageous that it is, by providing thin areas in the strip, achieved that the strip may be stretched in longitudinal direction on the side of the greater outside radius. Therefore, corresponding radii may be reduced, with the result that more strips may be cut from one square meter of fabric. It has surprisingly turned out that those thin areas do not or not considerably modify the properties of the friction material or of the friction layer, since these thin areas can be more or fess compensated while the friction material is attached to the conical surface, so that the friction material or the finished friction layer is embodied to be at least approximately “planar”. Planar does here not mean that the friction layer is embodied to be completely smooth, but it has a characteristic surface structure so that the friction layer can perform its task as it is known from prior art. It is also possible to keep those thin areas as functional depressions in the friction material or friction layer or those may be leveled out to only a certain extent with the result that the friction material can be adapted to the operation purpose in a better way.

Within the context of the invention, the term thin area is considered to be a region of the strip that has a lower layer thickness compared to the directly following adjacent regions.

According to one variant of embodiment of the friction layer it is provided that the thin areas are embodied as grooves. The advantage of this variant of embodiment is that those grooves can also be present on the friction layer attached to the contact surface and can be used as functional depressions in the finished friction material as it has been mentioned above. This planar expansion of the thin areas can furthermore have a positive influence on the stretch behavior of the strip.

As a special embodiment having a layer thickness of 0, the thin areas can be designed as slots. The advantage of the slots is on the one hand that the base body of the friction material is less influenced by the stretching during the attachment to the contact surface of the friction element. Furthermore, the slots can be closed more easily during the attachment to the contact surface, with the result that the above-mentioned planar surface of the attached friction layer can be produced more easily. It is furthermore easier to produce slots than grooves.

It can furthermore be provided that the grooves or slots extend at least approximately orthogonally with respect to the length of the strip. It is in this case of advanatge that the friction material is at least approximately evenly stretched during the attachment to the contact surface of the friction element.

It is on the other hand also possible to direct the slots or grooves at an angle with respect to the length of the strip, which angle is selected from a range having a lower limit of 10° and an upper limit of 75°, with the result that the stretching in a pre-definable direction can be given. It is thereby also achieved that the slots or grooves in the finished friction element are also oriented transversely with respect to the length of the strip, with the result that it is possible for the latter to be exposed to higher stresses, as thereby other power flow directions may be pre-defined in the region of these slots or grooves.

According to another variant of embodiment of the friction material, the strip is embodied to be straight. Thereby, the offcut can be reduced to a minimum. Furthermore, also other variants of embodiment can be realized thereby, the base body of which variants comprises a fabric including warp threads and weft threads, with the warp threads extending continuously and uninterruptedly along the entire length of the strip or the weft threads being embodied to extend at least approximately parallel with the edges of the short sides. Thus, the load capacity of the friction material can be influenced in a positive way.

For a better understanding of the invention the latter is explained in more detail with reference to the following Figures.

In a simplified, schematic representation:

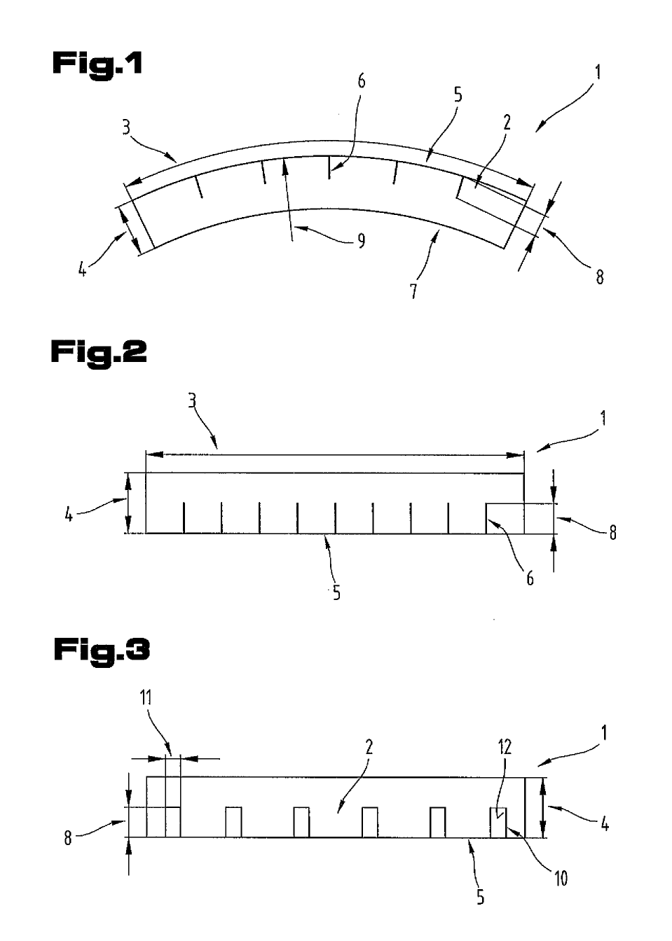

FIG. 1 shows a first variant of embodiment of a friction material in top view;

FIG. 2 shows a second variant of embodiment if a friction material in top view;

FIG. 3 shows a third variant of embodiment of a friction material in top view;

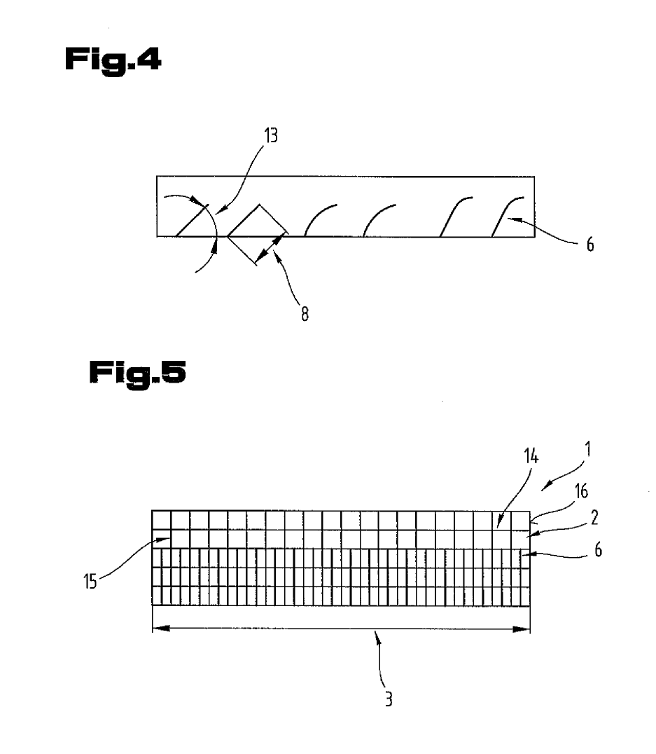

FIG. 4 shows different patterns;

FIG. 5 shows a further variant of embodiment of a friction material in top view.

First of all, it should be noted that in the variously described exemplary embodiments the same parts have been given the same reference numerals and the same component names, whereby the disclosures contained throughout the entire description can be applied to the same parts with the same reference numerals and same component names. Also details relating to position used in the description, such as e.g. top, bottom, side etc. relate to the currently described and represented figure and in case of a change in position should be adjusted to the new position.

FIG. 1 shows a first variant of embodiment of a friction material 1. This friction material 1 comprises or is made of a base body having the form of a strip 2. This strip 2 has a length 3 and a width 4, the length 3 of this variant of embodiment indicates the maximum length of the strip at a convexly curved outer edge 5, as shown in FIG. 1.

The strip 2 has thin areas along the outer edge 5, which thin areas are designed as slots 6 in the concrete variant of embodiment according to FIG. 1. Those thin areas, i.e. the slots 6 of variant of embodiment according to FIG. 1 extend in direction of the width 4 of the strip 2, or in direction towards an interior, concavely curved inner edge 7 of the strip 2. Furthermore, the thin areas, i.e. the slots 6 of the variant of embodiment according to FIG. 1 extend only over a part of the width 4 of the strip 2, so that the inner edge 7 is embodied to have no interruptions and to be continuous as compared to the outer edge 5.

It is preferred if the longitudinal extension 8 of the thin areas in the direction of the width 4 of the strip 2 is selected from a range having a lower limit of 1% and an upper limit of 10% of the absolute value of an outside radius 9 which is preferably between 200 mm and 500 mm, but also up to 1200 mm.

It is preferred if between 6 and 106, in particular between 6 and 48, slots 6 or thin areas are disposed over the length 3. In particular with the variant of embodiment of the friction material 1 according to FIG. 1, between 1 and 5 slots 6 or thin areas are provided per segment of the circle having an angular field between 5° and 10°, in particular if the segment of the circle has a total angle of between 40° and 50°.

The variant of embodiment according to FIG. 1 has—as compared to generic strips known from prior art—the advantage that the outside radius 9 can be embodied to be smaller than in prior art or that the outside radius 9 can be embodied to have the same size as the inside radius at the inner edge 7, with the result that there is less offcut, as the strips in the pattern can be cut lying adjacent to one another more closely.

FIG. 2 shows a second variant of embodiment of the friction material 1. The strip 2 is in this case not embodied to be curved but to be straight. The lengths 3 of the outer edge 5 and the inner edge 7 of the strip 2 are of the same size.

The strip 2 also has slots 6. The longitudinal extension 8 of the slots in direction of the width 4 can be selected from a range having a lower limit of 20% and 90% of the value of the width 4. With regard to the number of the slots 6 it is referred to the above-mentioned explanations.

FIG. 3 is to illustrate that the thin areas in the strips 2 can also be designed as grooves. With regard to the number of the grooves 10 and their longitudinal extension 8 in the direction of the width 4 of the strip 2, it is referred to the explanations above.

The grooves 10 can have a groove width 11 which is selected from a range having a lower limit of 0.2% and an upper limit of 10%, in particular 5% of the total value of the length 3 of the strip 2.

The groove depth of the grooves 10 can be selected from a range having a lower limit of 10% and an upper limit of 100%, in particular from a range having a lower limit of 10% and an upper limit of 80%, of the maximal layer thickness of the strip 2.

The grooves can furthermore have a rectangular or square cross section—as viewed in top view. It is also possible that the cross section is designed to be trapezoid (symmetrical or oblique-angled), with the longer basic side of the trapezoid being designed at the outer edge 5. It is also possible for the grooves 10 to be embodied to be tapering in the direction towards the groove bottom 12.

In contrast to the thin areas being designed as slots 6, also the outer edge 5 of the strip 2 is designed to be uninterrupted if they are embodied as grooves 10.

With the variants of embodiment of the friction material 1 according to FIGS. 1 to 3, the slots 6 or the grooves 10 or the thin areas in general run at least approximately, in particular exactly orthogonally towards the outer edge 5. It is within the scope of the invention also possible that the slots 6 or the grooves 10 or the thin areas in general are oriented at an angle 13 with respect to the length 3, i.e. to the outer edge 5 of the strip 2. To this end, FIG. 4 shows different embodiments of the thin areas, in particular as slots 6, and these illustrations can also be transposed to the grooves 10 according to FIG. 3. This being the case, the thin areas can run in a straight manner, as it is the case in the variants of embodiment according to the FIGS. 1 to 3, as it is illustrated in the left-hand part of FIG. 4. It is nevertheless also possible that the angle 13 changes within the course of the thin areas in the direction of their longitudinal direction 8, it becomes in particular smaller, as it is shown in the middle and right-hand part of the strip 2 according to FIG. 4. The transition between the individual angle regions—the thin areas may have more than two regions having a different inclination—may be embodied to be pointed or curved.

The angle 13 can be selected from a range having a lower limit of 10° and an upper limit of 75°, in particular from a range having a lower range of 24° and an upper limit of 60°.

With respect to the geometry of the thin areas, it is referred to the above-mentioned explanations.

The base body of the friction material 1 is preferably formed from a fabric or comprises a fabric, in particular a resin-impregnated fabric. It is preferred if the fabric is formed from carbon fibers, but it is nevertheless also possible for other materials to be used, as it is known from relevant prior art with respect to friction materials, in particular with respect to friction fabric.

It is known that fabric includes warp threads and weft threads. Due to the possibility to embody the strip 2 of the friction material 1 in a straight way, there is also the possibility that warp threads 14 of the fabric extend in an uninterrupted and continuous manner over the entire length 3 of the strip 2, as it is shown in FIG. 5. There is generally the possibility to produce the strip 2 in such a way that there is always the same number of warp threads over the length 3.

There is furthermore the possibility—as also shown in FIG. 6—that the warp threads 15 are embodied to run at least approximately parallel to the edges of the short side 16 of the strip 2. By inserting the slots 6, there is in particular also the possibility that the warp threads 15 are not cut.

It is in principle also possible for the strip 2 to be cut out in a direction transverse to the direction of the weft threads 15 or the warp threads 14 of the fabric. The warp threads 14 and the weft threads 15 can e.g. be arranged at an angle with respect to the longitudinal extension or the crosswise extension of the strip 2. The angle can e.g. be selected from a range between 1° and 10°. The angle can particularly be 5°. It is nevertheless also possible that the angle is greater than 10°.

The slots 6 can be cut or punched into the strips 2. The grooves 10 can e.g. be pressed or impressed by means of a corresponding forming tool.

It is furthermore possible that the thin areas are arranged to be spread evenly over the length 3 of the strip, i.e. having an essentially constant distance to one another. There is on the other hand also the possibility that the thin areas are spread over the length 3 of the strip 2 in an uneven manner, e.g. that two or more thin areas are united to form modules of thin areas, with the distances between the thin areas within a module of thin areas being shorter than the distances between two subsequent modules of thin areas.

It is also possible to use another fiber material instead of the fabric, e.g. nonwoven fiber composite materials.

It is furthermore possible that the strip 2 is designed to be single- or multi ply, such as e.g. two or three ply, and the individual plies can be made of a fiber material.

The friction material 1 is provided for an arrangement on a conical surface of a friction element, such as a double-cone ring of a transmission synchronization. To this end, the friction element has a conical contact surface for the friction material 1, where the friction material is connected to, in particular glued to. The connecting can be made by means of an adhesive or resin, and is also possible to use the resin of the fabric or the strip 2 for this purpose. The connecting is preferably carried out under pressure and at elevated temperature, with the temperature being nevertheless below the melting temperature of the resin. It is thus achieved that the resin or the adhesive can be brought into the slots 6 so that those slots 6 “close” again, after they have—due to the conical shape of the contact surface—expanded in the region of the outer edge 5 of the strip 2 while the friction material 1 was being disposed onto this contact surface, with the result that it may be recognized in the finished friction element that there are slots 6 are in the friction material 1, but the cutting edges of the slots 6 are however embodied to be adjacent to one another.

It is also possible for the friction material 1 to be compressed while it is disposed onto the conical surface.

The exemplary embodiments show possible embodiment variants friction material 1, whereby it should be noted at this point that the invention is not restricted to the embodiment variants shown in particular, but rather various different combinations of the individual embodiment variants are also possible and this variability, due to the teaching on technical procedure, lies within the ability of a person skilled in the art in this technical field.

Finally, as a point of formality, it should be noted that for a better understanding of the structure of the friction material 1 the latter and its components have not been represented true to scale in part and/or have been enlarged and/or reduced in size.

### LIST OF REFERENCE NUMERALS

1 Friction material
2 Strip
3 Length
4 Width
5 Outer edge
6 Slot
7 Inner edge
8 Longitudinal extension
9 Outside radius
10 Groove
11 Groove width
12 Groove bottom
13 Angle
14 Warp thread
15 Weft thread
16 Edge of short side

1. Friction material (1) for a friction element having a conical contact surface for the friction material (1), with a base body having the form of a strip (2) having a length (3) and a width (4), wherein the strip (2) has several thin areas only extending over a part of the width (4) of the strip (2).

2. Friction material (1) as claimed in claim 1, wherein the thin areas are designed as grooves (10).

3. Friction material (1) as claimed in claim 1, wherein the thin areas are designed as slots (6).

4. Friction material (1) as claim 1, wherein the grooves (10) or slots (6) run at least approximately orthogonally with respect to the length (3) of the strip (2).

5. Friction material (1) as claimed in claim 1, wherein the grooves (10) or slots (6) are oriented at an angle (13) with respect to the length of the strip (2), which angle is selected from a range having a lower limit of 10° and an upper limit of 75°.

6. Friction material (1) as claimed in claim 1, wherein the strip (2) is designed to be straight.

7. Friction material (1) as claimed in claim 1, wherein the base body comprises a fabric having warp threads (14) and weft threads (15), with the warp threads (14) extending continuously and uninterruptedly over the entire length (3) of the strip (2).

8. Friction material (1) as claimed in claim 7, wherein the weft threads (15) are embodied to extend at least approximately parallel with the edges of the short side (16) of the strip (2).

9. Friction element having a conical contact surface whereon a friction material (1) having the form of a strip (2) is arranged, wherein the friction material (1) is designed according to claim 1.
